(19) United States
(12) Patent Application Publication
(10) Pub. No.: US 2004/0194752 A1
(43) Pub. Date: Oct. 7, 2004

(54) Floating crank shaft

(76) Inventor: Victor Rudolph Bloomquist, Brush Prairie, WA (US)

Correspondence Address: Victor Bloomquist, 13718 NE 182 Ave,, Brush Prairie, WA, 98606, US

(21) Appl. No.: 10/406,102

(22) Filed: Apr. 4, 2003

(51) Int. Cl. F02B 75/32

(52) U.S. Cl. 123/197.1

(57) ABSTRACT

AN engine with two crank shafts one stationary, or secured to the block by conventional main bearings. The other crank referred to as the floating crank moves in a radius back and forth along one side of the stationary crank. The cranks drive each other by being geared together. A conventional piston and con rod is attached to the floating crank and drives the floating crank in rotating and down motions. Both of the motions rotate the stationary crank. Each piston has it's own floating crank seperate from the other pistons. The cranks rotate in opposite directions. The floating crank operates in position by two radius rods connected between the two crank shafts, two rods from the floating crank to the stabilizer rod and control rod, all of the four rods pined together where they meet. The other end of the control rod is connected to the stationary crank journal. The other end of the stabilizer rod is anchored in the engine block by a pivot pin.

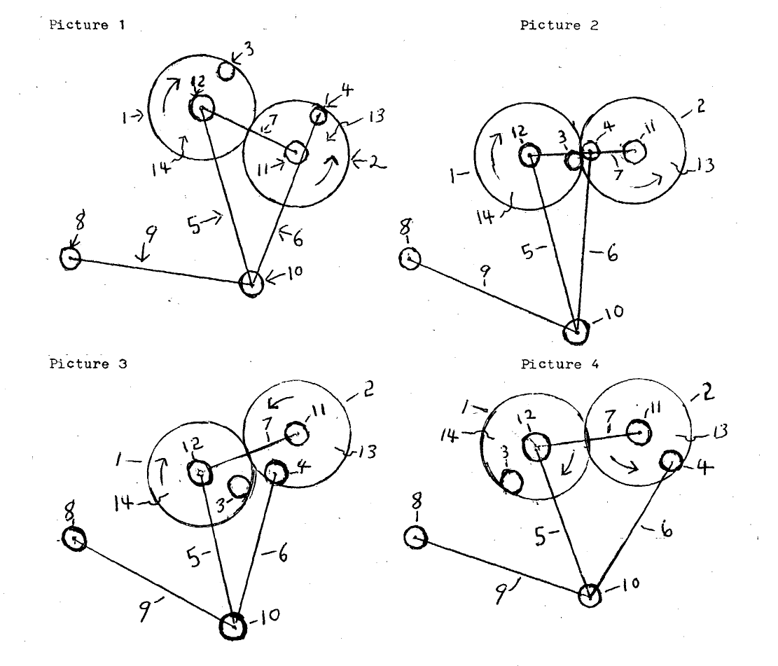

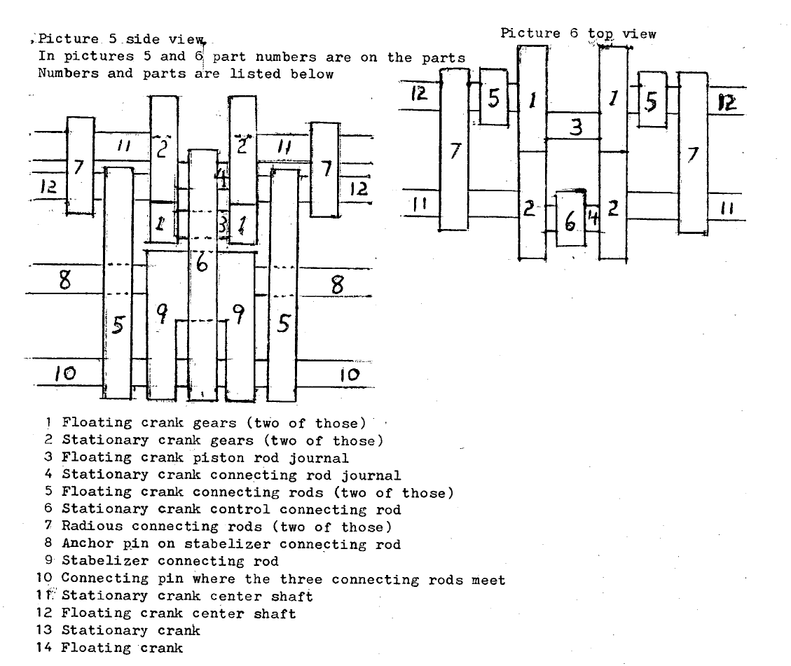

For the purpose of describing the invention the parts are numbered in the drawings. The invention is a new way to apply power to the rotation of crank shafts in an engines.

To get a more clear understanding of the invention, one page with four drawings viewed from the end of the crank shafts are included. The four drawings show the greater part of one revolution on the crank shafts. Also included is one page with two drawings showing top and side view of the crank shafts and rods.

### BACKGROUND

The purpose of this invention is to improve torc in engines. This is accomplished by applying the push force to the outer radius of the crank travel for a longer distance than the conventional crank shaft engine. This is done by a floating crank shaft which moves up and down along one side of a stationary crank shaft. The floating crank and the stationary crank are geared together so that they turn each other as the forces of the power stroke are applied in the different cycles. The piston rod is connected to the floating crank. The power is applied to the floating crank which pushes on the outer radius of the stationary crank, this then gives the improved torc on the stationary crank. The floating crank, the way it is mounted, secured, and the way it applies power to the stationary crank is the invention.

### DESCRIPTION

The floating crank shaft is held in place by the two radius connecting rods (7) and (7) running from the stationary crank center shaft (11), then to the floating crank center shaft (12). The floating crank connecting rods (5) and (5) connect to the control rod (6) and the stabilizer connecting rod (9) at connecting pin (10). The pivot end of stabilizer rod (9) is anchored into the engine block by anchor pin (8).

Power is applied to the floating crank piston rod journal (3) by a conventional piston and connecting rod. The fireing position is shown in picture 1; with rod jounal (3) approximately 30 degrees after top dead center with the piston not loseing elevation. This is accomplished because, the stationary crank control connecting rod journal (4) is timed 60 degrees behind the floating crank piston rod journal (3). The floating crank journal (3) is still riseing as it passes top dead center and on until approximately 30 degrees past top dead center. This rise happens because control rod (6) is still being pulled up on the return up side on the stationary crank (13); this gos on until journal (4) is approximately 30 degrees before top dead center. The control rod (6) is connected to the floating crank connecting rods (5) and (5) at connecting pin (10); with this connection,control rod (6) raises, lowers, and controls the elevation of the floating crank (14) at all times. From 330 degrees to 360 degrees on the stationary crank journal (4) the control rod (6) has almost no up and down motion; this puts all the torc from the floating crank gears (1) and (1) on to the stationary crank gears (2) and (2). The power being on the outer radius of the stationary crank (13) it should yield more torc than the conventional crank engine early in the power stroke. As the crank journal (4) moves past top dead center the control rod (6), which is under down pressure from the floating crank connecting rods (5) and (5), helps to pull the stationary crank (13) through the power cycle. The power stroke has two drive forces on the stationary crank (13). One is applied by the gears (1) and (1) onto the gears (2) and (2). The other force is applied by the control rod (6) pulling down on the rod journal (4). Each of the forces alternate in to advantageous positions so as to keep a very good torc position on the crank radius through out the power stroke.

At the beginning of the power stroke, picture 1 shows good torc advantage for the gears (1) and (1) on (2) and (2). In picture 2 the power stroke is in an intermediate position, the piston rod journal (3) is putting almost a perfect torc position on the gears (1) and (1) on (2) and (2); while also getting a perfect torc position for control rod (6) pulling down on journal (4). In picture 3 the power stroke is approximately three quarters complete. In this position the control rod (6) holds the floating crank (14) almost stationary in up and down motion, while the piston rod journal (3) finishes the power stroke in a very good torc position through rotation of the gears (1) and (1) on gears (2) and (2). Picture 4 shows the returning of the two cranks toward their position in picture 1. Picture 5 shows the side view of the crank shafts and rods. In picture 5 the floating crank gears (1) and (1) are behind stationary crank gears (2) and (2) and only show partially. Picture 6 shows the top view of the crank shafts and rods.

### BRIEF SUMMARY

The floating crank shaft has some innate advantages over the conventional crank shaft engine. One is the piston is at 30 degrees past top dead center at fireing position with out loss of piston height. Another advantage is the push force is held more to a longer radius on the stationary crank, long radius meaning 90 degrees to the top dead center line. This longer radius is held for a longer period of travel on the power stroke. The above described advantage should produce more efficency per pound of fuel burned.

1. The floating crank shaft invention has a 25% longer power stroke per crank shaft diameter than a conventional crank shaft engine.

2. The floating crank shaft invention has 25% or better torc angle advantages on the driven crank radius; this should be evident when comparing power strokes between it and the conventional crank shaft engine.

3. The power stroke starts 30 degrees after top dead center with no loss in piston elevation. This gives more torc at the start of the power stroke than a conventional crank engine which fires almost on top dead center, and has no torc at all until the crank moves past top dead center.
